(19) United States
(12) Patent Application Publication
(10) Pub. No.: US 2018/0107062 A1
(43) Pub. Date: Apr. 19, 2018

(54) BACKLIGHT MODULE AND ASSEMBLY METHOD THEREOF

(71) Applicant: Wuhan China Star Optoelectronics Technology Co., Ltd., Wuhan City (CN)

(72) Inventors: Jie Zeng, Wuhan City (CN); Shihhsiang Chen, Wuhan City (CN); Gege Zhou, Wuhan City (CN)

(21) Appl. No.: 15/112,188

(22) PCT Filed: May 18, 2016
(86) PCT No.: PCT/CN2016/082557

§ 371 Date: Jul. 17, 2016

(30) Foreign Application Priority Data
May 3, 2016 (CN) 201610287479.0

(51) Int. Cl. G02F 1/1335; F21V 8/00; G02F 1/1333

(52) U.S. Cl. CPC G02F 1/133602; G02F 1/133308; G02B 6/0025

(57) ABSTRACT

The present invention provides a backlight module and an assembly method thereof. The backlight module is structured such that a first double-sized adhesive tape (10) that adhesively bonds a light-source flexible circuit board (5) and a light guide plate (3) is extended in length thereof so that the first double-sized adhesive tape (10) adhesively bonds a diffuser plate (61), the light-source flexible circuit board (5), and the light guide plate (3) together. In comparison with the prior art, the fixation of the diffuser plate (61) can be achieved without adding a connection member and can effectively prevent sliding of the diffuser plate (61) to cause abrasion with the light guide plate (3) that affects optical taste of backlighting and has a simple structure and reduced manufacturing cost. The assembly method of the backlight module allows for easy and efficient completion of the assembly of the backlight module so that the manufacturing cost is reduced and the production efficiency is high.

### BACKGROUND OF THE INVENTION

### 1. Field of the Invention

The present invention relates to the field of liquid crystal display technology, and in particular to a backlight module and an assembly method thereof.

### 2. The Related Arts

Liquid crystal displays (LCDs) have a variety of advantages, such as thin device body, low power consumption, and being free of radiation, and thus have wide applications, such as liquid crystal televisions, mobile phones, personal digital assistants (PDAs), digital cameras, computer monitors, and notebook computer screens, making them in a leading position in the field of flat panel displays.

Most of the LCDs that are currently available in the market are backlighting LCDs, which comprise a liquid crystal panel and a backlight module. The working principle of the liquid crystal panel is that a drive voltage is applied to a thin-film transistor (TFT) array substrate and a color filter (CF) substrate to control a rotation direction of liquid crystal molecules located between the two substrates in order to refract out light emitting from the backlight module to generate an image.

Since the LCDs are non-luminous display devices, the functionality of displaying can only be achieved with the assistance of the backlight module. The performance of the backlight module directly affects the image quality displayed with an LCD and it also takes about 30-50% of the costs of the liquid crystal display module and consumes about 75% of electrical power supplied to the module so that it is a very important component of the liquid crystal display module. For high-definition large-sized LCDs, there must be high-performance backlight module used in combination therewith. Thus, in the moment when the LCD industry is working industriously for developing applications in new fields, enhancement of performance of the backlight module, such as high brightness, low cost, low power consumption, and being made light and small, also takes an important part.

Referring to FIG. 1, a schematic view is given to illustrate the structure of a conventional backlight module, which comprises: a mold frame 1′, a first double-sized adhesive tape 10′ disposed on a lower surface of the mold frame 1′, a reflector plate 2′ adhesively bonded to the lower surface of the mold frame 1′ by the first double-sized adhesive tape 10′, a light guide plate 3′ disposed on the reflector plate 2′, a diffuser plate 6′ disposed on the light guide plate 3′, a prism plate 7′ disposed on the diffuser plate 6′, a backlight source 4′ disposed between the mold frame 1′ and the light guide plate 3′, a circuit board 5′ disposed on the backlight source 4′ and electrically connected to the backlight source 4′, a second double-sized adhesive tape 20′ disposed on a lower surface of the circuit board 5′ and adhesively attached to an upper surface of the light guide plate 3′, a third double-sized adhesive tape 30′ disposed on the lower surface of the circuit board 5′ and adhesively attached to an upper surface of the mold frame 1′, a light-shielding adhesive tape 40′ disposed on a side portion of an upper surface of the prism plate 7′ and adhesively attached to an upper surface of the mold frame 1′, and a connection member 8′ arranged on a side portion of an upper surface of the diffuser plate 6′ that is adjacent to the backlight source 4′ and adhesively attached to the light-shielding adhesive tape 40′. At one side adjacent to the backlight source 4′, the diffuser plate 6′ has a length that is greater than that of the prism plate 7′ to provide a space for fixing the diffuser plate 6′. The light guide plate 3′ of the backlight module is a light guide plate having a wedge-shaped structure, where a light exit surface at one side there that is distant from the backlight source 4′ is thinner than a light incident surface at one side thereof that is adjacent to the backlight source 4′. To have the diffuser plate 6′ securely fixed and prevented from sliding and thus causing abrasion with respect to the light guide plate 3′ to influence the quality of backlighting, the connection member 8′ is arranged on one side of the upper surface of the diffuser plate 6′ that is adjacent to the backlight source 4′ so that the diffuser plate 6′ can be fixed by being adhesively bonded to the light-shielding adhesive tape 40′. Such an arrangement of fixing the diffuser plate 6′ would increase the material cost and the cutting cost of the optical films thereby increasing the production cost of the backlight module.

### SUMMARY OF THE INVENTION

An object of the present invention is to provide a backlight module, which allows for mounting of a diffuser plate without adding a connection member, thereby simplifying the structure of the backlight module and lowering down the manufacturing cost.

Another object of the present invention is to provide an assembly method of a backlight module, which allows for easy and efficient assembly a backlight module and thus helps lower down the manufacturing cost and provides manufacturing efficiency.

To achieve the above objects, the present invention provides a backlight module, which comprises: a mold frame, a light guide plate disposed inside the mold frame, a backlight source disposed between the mold frame and the light guide plate, a light-source flexible circuit board disposed on the backlight source and electrically connected to the backlight source, and an optical film assembly disposed on an upper surface of the light guide plate;

the optical film assembly comprising: a diffuser plate and a prism plate disposed on the diffuser plate, the diffuser plate having an end that is adjacent to the backlight source and extends beyond an end of the prism plate that is adjacent to the backlight source;

the light guide plate having an upper surface on which a first double-sized adhesive tape is provided, the first double-sized adhesive tape comprising: a light-source flexible circuit board attaching section located between the light guide plate and the light-source flexible circuit board and a diffuser plate attaching section extending from the light-source flexible circuit board attaching section such that the first double-sized adhesive tape adhesively bonds the light-source flexible circuit board, the light guide plate, and the diffuser plate together.

The diffuser plate has an upper surface that is adhesively bonded and fixed to a lower surface of the diffuser plate attaching section of the first double-sized adhesive tape.

The diffuser plate has a lower surface that is adhesively bonded and fixed to an upper surface of the diffuser plate attaching section of the first double-sized adhesive tape.

The backlight module further comprises: a reflector plate disposed on a lower surface of the mold frame.

A second double-sized adhesive tape is arranged between the lower surface of the mold frame and an upper surface of the reflector plate such that the second double-sized adhesive tape adhesively bonds and fixes the mold frame and the reflector plate together;

a third double-sized adhesive tape being arranged between a lower surface of the light-source flexible circuit board and an upper surface of the mold frame such that the third double-sized adhesive tape adhesively bonds and fixes the light-source flexible circuit board and the mold frame together;

a light-shielding adhesive tape being arranged on an upper surface of the mold frame and an edge portion of an upper surface of the prism plate such that the light-shielding adhesive tape adhesively bonds and fixes the prism plate and the mold frame together.

The present invention also provides an assembly method of a backlight module, which comprises the following steps:

(1) providing a mold frame, a light guide plate, and a backlight source and assembling and fixing the mold frame, the light guide plate, the backlight source such that the light guide plate is located inside the mold frame and the backlight source is located between the mold frame and the light guide plate;

(2) providing an optical film assembly, a light-source flexible circuit board, and a first double-sized adhesive tape;

wherein the optical film assembly comprises: a diffuser plate and a prism plate, where the diffuser plate has a length greater than a length of the prism plate; and

wherein the first double-sized adhesive tape comprises: a light-source flexible circuit board attaching section and a diffuser plate attaching section extending from the light-source flexible circuit board attaching section, where first protection films and second protection films are provided to respectively correspond to the light-source flexible circuit board attaching section and the diffuser plate attaching section;

(3) peeling off the first protection films, adhesively attaching the upper surface of the light-source flexible circuit board attaching section of the first double-sized adhesive tape to a lower surface of the light-source flexible circuit board, positioning the light-source flexible circuit board on the backlight source and electrically connected to the backlight source, and adhesively attaching the lower surface of the light-source flexible circuit board attaching section of the first double-sized adhesive tape to an upper surface of the light guide plate;

(4) peeling off the second protection films, positioning the diffuser plate on the light guide plate, and adhesively attaching the diffuser plate attaching section of the first double-sized adhesive tape to the diffuser plate; and

(5) fixing the prism plate to the diffuser plate to complete the assembly of the backlight module.

In Step 4, an upper surface of the diffuser plate is adhesively attached to a lower surface of the diffuser plate attaching section of the first double-sized adhesive tape.

In Step 4, a lower surface of the diffuser plate is adhesively attached to an upper surface of the diffuser plate attaching section of the first double-sized adhesive tape.

Step 1 further comprises providing a reflector plate, where in assembly, the reflector plate is disposed on a lower surface of the mold frame.

In Step 1, a second double-sized adhesive tape is arranged between a lower surface of the mold frame and an upper surface of the reflector plate such that the second double-sized adhesive tape adhesively bonds and fixes the mold frame and the reflector plate together;

In Step 3, a third double-sized adhesive tape is arranged between a lower surface of the light-source flexible circuit board and an upper surface of the mold frame such that the third double-sized adhesive tape adhesively bonds and fixes the light-source flexible circuit board and the mold frame together; and

In Step 5, a light-shielding adhesive tape is arranged on an upper surface of the mold frame and an edge portion of an upper surface of the prism plate such that the light-shielding adhesive tape adhesively bonds and fixes the prism plate and the mold frame together.

The present invention further provides a backlight module, which comprises: a mold frame, a light guide plate disposed inside the mold frame, a backlight source disposed between the mold frame and the light guide plate, a light-source flexible circuit board disposed on the backlight source and electrically connected to the backlight source, and an optical film assembly disposed on an upper surface of the light guide plate;

the optical film assembly comprising: a diffuser plate and a prism plate disposed on the diffuser plate, the diffuser plate having an end that is adjacent to the backlight source and extends beyond an end of the prism plate that is adjacent to the backlight source;

the light guide plate having an upper surface on which a first double-sized adhesive tape is provided, the first double-sized adhesive tape comprising: a light-source flexible circuit board attaching section located between the light guide plate and the light-source flexible circuit board and a diffuser plate attaching section extending from the light-source flexible circuit board attaching section such that the first double-sized adhesive tape adhesively bonds the light-source flexible circuit board, the light guide plate, and the diffuser plate together;

further comprising: a reflector plate disposed on a lower surface of the mold frame;

wherein a second double-sized adhesive tape is arranged between the lower surface of the mold frame and an upper surface of the reflector plate such that the second double-sized adhesive tape adhesively bonds and fixes the mold frame and the reflector plate together;

a third double-sized adhesive tape being arranged between a lower surface of the light-source flexible circuit board and an upper surface of the mold frame such that the third double-sized adhesive tape adhesively bonds and fixes the light-source flexible circuit board and the mold frame together;

a light-shielding adhesive tape being arranged on an upper surface of the mold frame and an edge portion of an upper surface of the prism plate such that the light-shielding adhesive tape adhesively bonds and fixes the prism plate and the mold frame together.

The efficacy of the present invention is that the present invention provides a backlight module, in which a first double-sized adhesive tape that adhesively bonds a light-source flexible circuit board and a light guide plate is extended in length thereof so that the first double-sized adhesive tape adhesively bonds a diffuser plate, the light-source flexible circuit board, and the light guide plate together. In comparison with the prior art, the fixation of the diffuser plate can be achieved without adding a connection member and can effectively prevent sliding of the diffuser plate to cause abrasion with the light guide plate that affects optical taste of backlighting and has a simple structure and reduced manufacturing cost. The present invention provides an assembly method of a backlight module, which allows for easy and efficient completion of assembly of a backlight module so that the manufacturing cost is reduced and the production efficiency is high.

### BRIEF DESCRIPTION OF THE DRAWINGS

The features and technical contents of the present invention will be better understood by referring to the following detailed description and drawings the present invention. However, the drawings are provided for the purpose of reference and illustration and are not intended to limit the scope of the present invention.

In the drawing:

FIG. 1 is a schematic view illustrating the structure of a conventional backlight module;

FIG. 2 is a schematic view illustrating the structure of a backlight module according to a first embodiment of the present invention;

FIG. 3 is a schematic view illustrating the structure of a protection film of the backlight module according to the present invention;

FIG. 4 is a schematic view illustrating the structure of a backlight module according to a second embodiment of the present invention; and

FIG. 5 is a flow chart illustrating an assembly method of a backlight module according to the present invention.

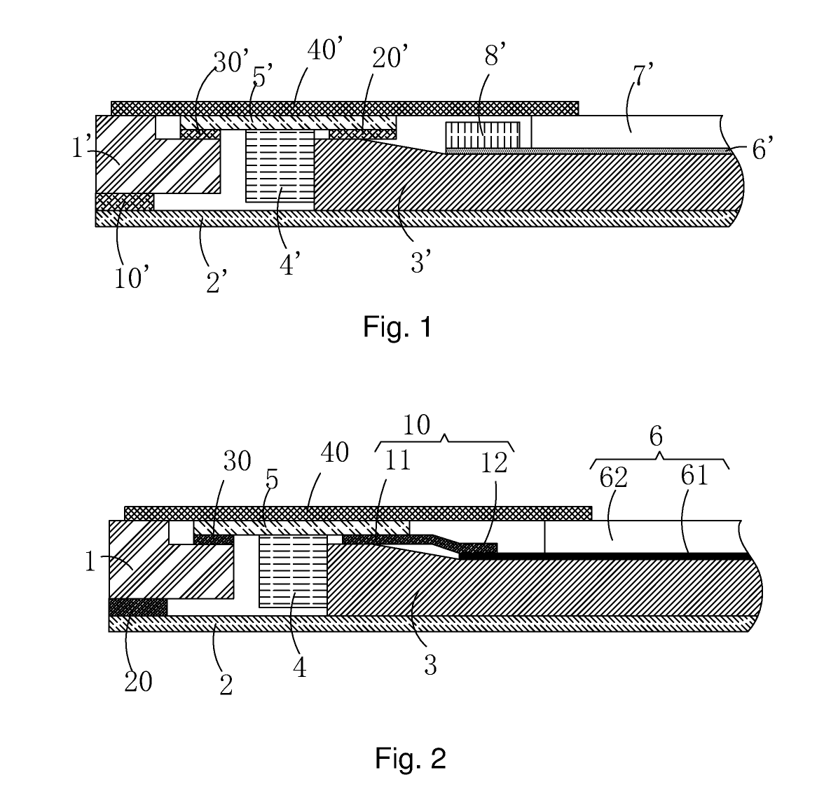

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

Referring to FIG. 2, a schematic view is given to illustrate a structure of a backlight module according to a first embodiment of the present invention, which comprises: a mold frame 1, a light guide plate 3 disposed inside the mold frame 1, a backlight source 4 disposed between the mold frame 1 and the light guide plate 3, a light-source flexible circuit board 5 disposed on the backlight source 4 and electrically connected to the backlight source 4, and an optical film assembly 6 disposed on an upper surface of the light guide plate 3.

The optical film assembly 6 comprises: a diffuser plate 61 and a prism plate 62 disposed on the diffuser plate 61. The diffuser plate 61 has an end that is adjacent to the backlight source 4 and extends beyond an end of the prism plate 62 that is adjacent to the backlight source 4.

The light guide plate 3 has an upper surface on which a first double-sized adhesive tape 10 is provided. The first double-sized adhesive tape 10 comprises: a light-source flexible circuit board attaching section 11 located between the light guide plate 3 and the light-source flexible circuit board 5 and a diffuser plate attaching section 12 extending from the light-source flexible circuit board attaching section 11 such that the first double-sized adhesive tape 10 adhesively bonds the light-source flexible circuit board 5, the light guide plate 3, and the diffuser plate 61 together.

Further, the mold frame 1 has a lower surface on which a reflector plate 2 is provided. A second double-sized adhesive tape 20 is arranged between the lower surface of the mold frame 1 and an upper surface of the reflector plate 2. The second double-sized adhesive tape 20 adhesively bonds and fixes the mold frame 1 and the reflector plate 2 together. A third double-sized adhesive tape 30 is arranged between a lower surface of the light-source flexible circuit board 5 and an upper surface of the mold frame 1. The third double-sized adhesive tape 30 adhesively bonds and fixes the light-source flexible circuit board 5 and the mold frame 1 together. A light-shielding adhesive tape 40 is arranged on an upper surface of the mold frame 1 and an upper surface of an edge portion of the optical film assembly 6 and the light-shielding adhesive tape 40 adhesively bonds and fixes the optical film assembly 6 and the mold frame 1 together.

Further, the light-source flexible circuit board 5 controls the backlight source 4 to emit light. The light emitting from the backlight source 4 gets incident onto the light guide plate 3 and is guided toward the upper surface and a lower surface of the light guide plate 3, wherein light that is guided toward the lower surface of the light guide plate 3 is reflected by the reflector plate 2 back to ill the light guide plate 3 to project out through the upper surface of the light guide plate 3, while light that is guided toward the upper surface of the light guide plate 3 is allowed to directly project out. The light that is projected out through the upper surface of the light guide plate 3 passes through the optical film assembly 6 to project out of the backlight module thereby forming a planar light source supplied to a liquid crystal panel.

It is noted here that, referring to FIG. 2, the diffuser plate 61 has a length that is greater than a length of the prism plate 62 at the side adjacent to the backlight source 4 and the portion of the length of the diffuser plate 61 that extends beyond the prism plate 62 provides a space for fixing the diffuser plate 61. The diffuser plate attaching section 12 of the first double-sized adhesive tape 10 extends to an area where the portion of the length of the diffuser plate 61 that extends beyond the prism plate 62 in order to fix the diffuser plate 61.

Specifically, referring to FIG. 2, in the first embodiment of the present invention, an upper surface of the diffuser plate 61 and a lower surface of the diffuser plate attaching section 12 of the first double-sized adhesive tape 10 are adhesively bonded and fixed together so that the diffuser plate 6 and the light guide plate 3 are adhesively bonded and fixed together. By having the length of the first double-sized adhesive tape 10 extended to form the diffuser plate attaching section 12 and having the diffuser plate attaching section 12 fix the diffuser plate 61 to the upper surface of the light guide plate 3, in comparison with the prior art, there is no need to add a connection member so that the material cost is reduced and in addition, there is no concern regarding the existence of any connection member during cutting the diffuser plate 61 so that the cutting cost is also reduced.

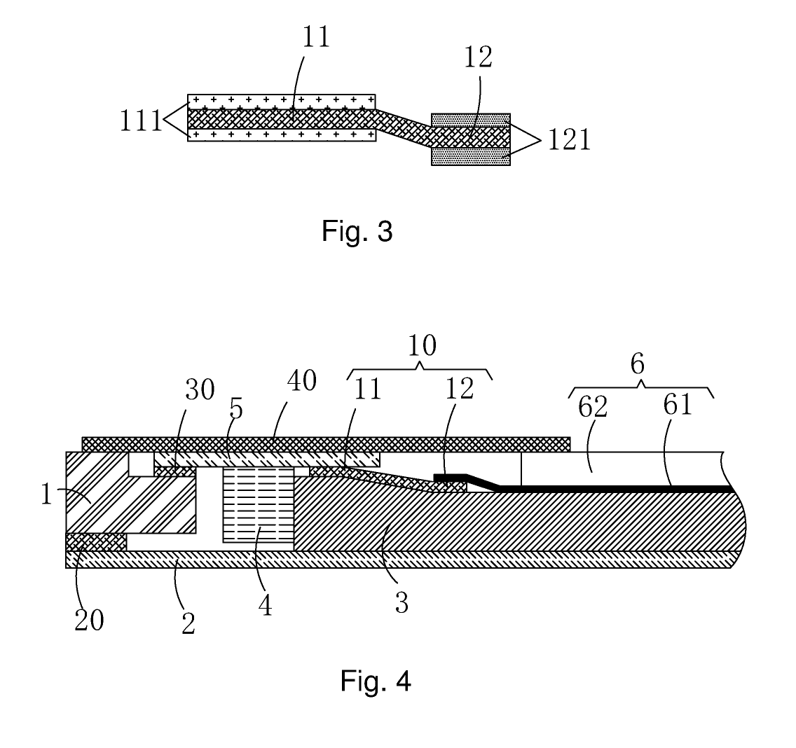

Further, referring to FIG. 3, before the first double-sized adhesive tape 10 is applied for bonding, upper and lower surfaces of the light-source flexible circuit board attaching section 11 and the diffuser plate attaching section 12 are respectively covered with first protection films 111 and second protection films 121. The first protection films 111 and the second protection films 121 are independent of each other and can be peeled and removed individually. To adhesively bond the light-source flexible circuit board 5 and the diffuser plate 61, the first and second protection films are individually peeled off to allow the light-source flexible circuit board attaching section 11 and the diffuser plate attaching section 12 to be respectively and adhesively attached to the light-source flexible circuit board 5 and the diffuser plate 61 so that the difficult of adhesively bonding the light-source flexible circuit board 5 and the diffuser plate 61 can be reduced.

Referring to FIG. 4, a schematic view is given to illustrate a structure of a backlight module according to a second embodiment of the present invention, the instant embodiment is different from the first embodiment in that an upper surface of the diffuser plate attaching section 12 of the first double-sized adhesive tape 10 is adhesively bonded to a lower surface of the diffuser plate 61 and a lower surface of the diffuser plate attaching section 12 of the first double-sized adhesive tape 10 is adhesively bonded to the light guide plate 3 so as to fix the diffuser plate 61 to the upper surface of the light guide plate 3 to complete fixation of the diffuser plate 61. The remaining is similar to those of the first embodiment and repeated description will be omitted.

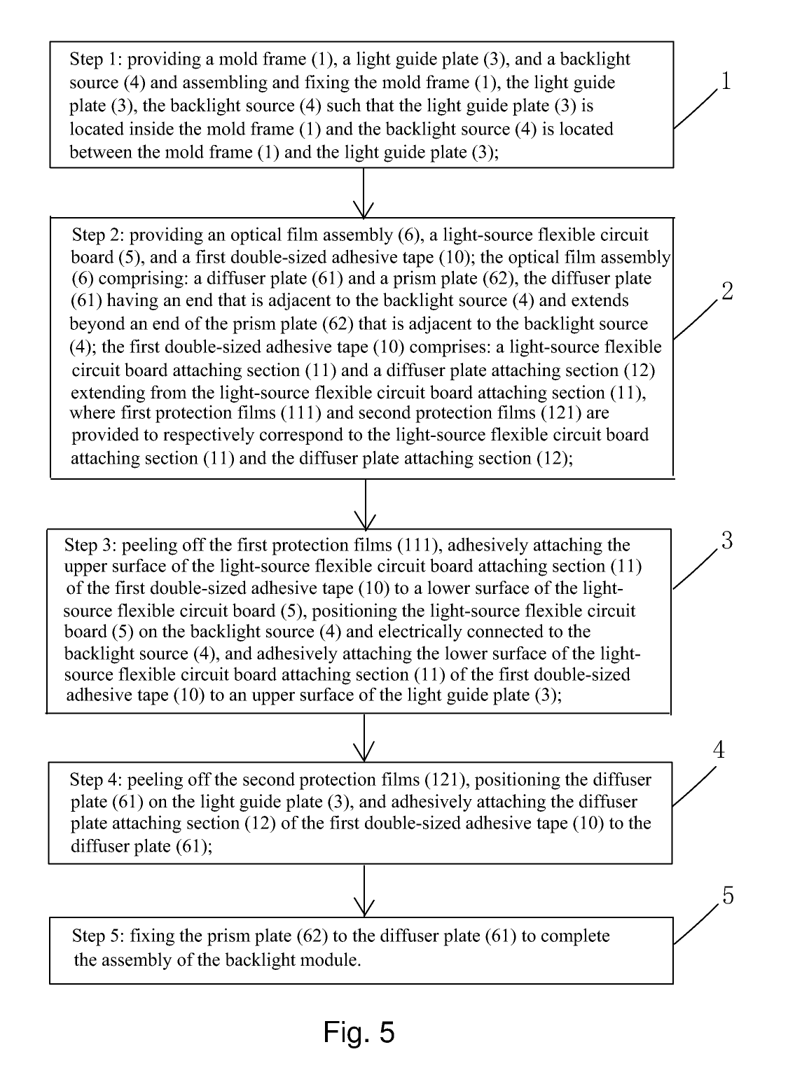

Referring to FIG. 5, the present invention also provides an assembly method of a backlight module, which comprises the following steps:

Step 1: providing a mold frame 1, a light guide plate 3, and a backlight source 4 and assembling and fixing the mold frame 1, the light guide plate 3, the backlight source 4 such that the light guide plate 3 is located inside the mold frame 1 and the backlight source 4 is located between the mold frame 1 and the light guide plate 3.

Specifically, the mold frame 1 has a lower surface that is further provided thereon with a reflector plate 2, such that the reflector plate 2 is adhesively bonded and fixed to the mold frame 1 by a second double-sized adhesive tape 20, where the second double-sized adhesive tape 20 is arranged, in a form of a rectangular frame, along a circumference around the mold frame 1.

Step 2: providing an optical film assembly 6, a light-source flexible circuit board 5, and a first double-sized adhesive tape 10.

The optical film assembly 6 comprises: a diffuser plate 61 and a prism plate 62, where the diffuser plate 61 has a length greater than a length of the prism plate 62.

The first double-sized adhesive tape 10 comprises: a light-source flexible circuit board attaching section 11 and a diffuser plate attaching section 12 extending from the light-source flexible circuit board attaching section 11, where first protection films 111 and second protection films 121 are provided to respectively correspond to the light-source flexible circuit board attaching section 11 and the diffuser plate attaching section 12.

Specifically, the first protection films 111 and the second protection films 121 respectively cover upper and lower surfaces of the light-source flexible circuit board attaching section 11 and the diffuser plate attaching section 12 and the first protection films 111 and the second protection films 121 are independent of each other and can be peeled off individually. The light-source flexible circuit board 5 controls the backlight source 4 to emit light.

Step 3: peeling off the first protection films 111, adhesively attaching the upper surface of the light-source flexible circuit board attaching section 11 of the first double-sized adhesive tape 10 to a lower surface of the light-source flexible circuit board 5, positioning the light-source flexible circuit board 5 on the backlight source 4 and electrically connected to the backlight source 4, and adhesively attaching the lower surface of the light-source flexible circuit board attaching section 11 of the first double-sized adhesive tape 10 to an upper surface of the light guide plate 3.

Specifically, Step 3 further comprising providing a third double-sized adhesive tape 30 and adhesively attaching the third double-sized adhesive tape 30 to a part of lower surface of the light-source flexible circuit board 5 that is distant from the light guide plate 3 so that the third double-sized adhesive tape 30 adhesively bonds and fixes the light-source flexible circuit board 5 and the mold frame 1 together.

Further, in Step 3, only the first protection films 111 are peeled off, while the second protection films 121 are not peeled off in order to prevent, during the operation of adhesively bonding the light-source flexible circuit board 5, the diffuser plate attaching section 12 that is for adhesively bonding the diffuser plate 61 from being attached to an incorrect position so that the difficult of adhesively bonding can be reduced and the operation efficiency can be improved.

Step 4: peeling off the second protection films 121, positioning the diffuser plate 61 on the light guide plate 3, and adhesively attaching the diffuser plate attaching section 12 of the first double-sized adhesive tape 10 to the diffuser plate 61.

With the arrangement of the second protection films 121, positional alignment between the diffuser plate 61 and the diffuser plate attaching section 12 can be done easily and adhesive attaching can be conducted only after the positional alignment so that the first double-sized adhesive tape 10 being mistakenly attached to an incorrect position during the positional alignment can be prevented.

Step 5: fixing the prism plate 62 to the diffuser plate 61 to complete the assembly of the backlight module.

Specifically, a side of the prism plate 62 that is distant from the backlight source 4 is in alignment with a side of the diffuser plate 61 that is distant from the backlight source 4, while a side of the diffuser plate 61 that is adjacent to the backlight source 4 extends beyond the prism plate 62. The diffuser plate attaching section 12 of the first double-sized adhesive tape 10 extends to an area where a portion of a length of the diffuser plate 61 that extends beyond the prism plate 62 exists in order to fix the diffuser plate 61.

Further, in Step 5, a light-shielding adhesive tape 40 is attached to an edge portion of an upper surface of the prism plate 62 and an upper surface of the mold frame 2 so as to adhesively bond and fix the optical film assembly 6 and the mold frame 2 together.

In summary, the present invention provides a backlight module, in which a first double-sized adhesive tape that adhesively bonds a light-source flexible circuit board and a light guide plate is extended in length thereof so that the first double-sized adhesive tape adhesively bonds a diffuser plate, the light-source flexible circuit board, and the light guide plate together. In comparison with the prior art, the fixation of the diffuser plate can be achieved without adding a connection member and can effectively prevent sliding of the diffuser plate to cause abrasion with the light guide plate that affects optical taste of backlighting and has a simple structure and reduced manufacturing cost. The present invention provides an assembly method of a backlight module, which allows for easy and efficient completion of assembly of a backlight module so that the manufacturing cost is reduced and the production efficiency is high.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising: a mold frame, a light guide plate disposed inside the mold frame, a backlight source disposed between the mold frame and the light guide plate, a light-source flexible circuit board disposed on the backlight source and electrically connected to the backlight source, and an optical film assembly disposed on an upper surface of the light guide plate;
the optical film assembly comprising: a diffuser plate and a prism plate disposed on the diffuser plate, the diffuser plate having an end that is adjacent to the backlight source and extends beyond an end of the prism plate that is adjacent to the backlight source;
the light guide plate having an upper surface on which a first double-sized adhesive tape is provided, the first double-sized adhesive tape comprising: a light-source flexible circuit board attaching section located between the light guide plate and the light-source flexible circuit board and a diffuser plate attaching section extending from the light-source flexible circuit board attaching section such that the first double-sized adhesive tape adhesively bonds the light-source flexible circuit board, the light guide plate, and the diffuser plate together.

2. The backlight module as claimed in claim 1, wherein the diffuser plate has an upper surface that is adhesively bonded and fixed to a lower surface of the diffuser plate attaching section of the first double-sized adhesive tape.

3. The backlight module as claimed in claim 1, wherein the diffuser plate has a lower surface that is adhesively bonded and fixed to an upper surface of the diffuser plate attaching section of the first double-sized adhesive tape.

4. The backlight module as claimed in claim 1 further comprising: a reflector plate disposed on a lower surface of the mold frame.

5. The backlight module as claimed in claim 4, wherein a second double-sized adhesive tape is arranged between the lower surface of the mold frame and an upper surface of the reflector plate such that the second double-sized adhesive tape adhesively bonds and fixes the mold frame and the reflector plate together;
a third double-sized adhesive tape being arranged between a lower surface of the light-source flexible circuit board and an upper surface of the mold frame such that the third double-sized adhesive tape adhesively bonds and fixes the light-source flexible circuit board and the mold frame together;
a light-shielding adhesive tape being arranged on an upper surface of the mold frame and an edge portion of an upper surface of the prism plate such that the light-shielding adhesive tape adhesively bonds and fixes the prism plate and the mold frame together.

6. An assembly method of a backlight module, comprising the following steps:
(1) providing a mold frame, a light guide plate, and a backlight source and assembling and fixing the mold frame, the light guide plate, the backlight source such that the light guide plate is located inside the mold frame and the backlight source is located between the mold frame and the light guide plate;
(2) providing an optical film assembly, a light-source flexible circuit board, and a first double-sized adhesive tape;
wherein the optical film assembly comprises: a diffuser plate and a prism plate, where the diffuser plate has a length greater than a length of the prism plate; and
wherein the first double-sized adhesive tape comprises: a light-source flexible circuit board attaching section and a diffuser plate attaching section extending from the light-source flexible circuit board attaching section, where first protection films and second protection films are provided to respectively correspond to the light-source flexible circuit board attaching section and the diffuser plate attaching section;
(3) peeling off the first protection films, adhesively attaching the upper surface of the light-source flexible circuit board attaching section of the first double-sized adhesive tape to a lower surface of the light-source flexible circuit board, positioning the light-source flexible circuit board on the backlight source and electrically connected to the backlight source, and adhesively attaching the lower surface of the light-source flexible circuit board attaching section of the first double-sized adhesive tape to an upper surface of the light guide plate;
(4) peeling off the second protection films, positioning the diffuser plate on the light guide plate, and adhesively attaching the diffuser plate attaching section of the first double-sized adhesive tape to the diffuser plate; and
(5) fixing the prism plate to the diffuser plate to complete the assembly of the backlight module.

7. The assembly method of the backlight module as claimed in claim 6, wherein in Step 4, an upper surface of the diffuser plate is adhesively attached to a lower surface of the diffuser plate attaching section of the first double-sized adhesive tape.

8. The assembly method of the backlight module as claimed in claim 6, wherein in Step 4, a lower surface of the diffuser plate is adhesively attached to an upper surface of the diffuser plate attaching section of the first double-sized adhesive tape.

9. The assembly method of the backlight module as claimed in claim 6, wherein Step 1 further comprises providing a reflector plate, where in assembly, the reflector plate is disposed on a lower surface of the mold frame.

10. The assembly method of the backlight module as claimed in claim 7, wherein
in Step 1, a second double-sized adhesive tape is arranged between a lower surface of the mold frame and an upper surface of the reflector plate such that the second double-sized adhesive tape adhesively bonds and fixes the mold frame and the reflector plate together;
in Step 3, a third double-sized adhesive tape is arranged between a lower surface of the light-source flexible circuit board and an upper surface of the mold frame such that the third double-sized adhesive tape adhesively bonds and fixes the light-source flexible circuit board and the mold frame together; and
in Step 5, a light-shielding adhesive tape is arranged on an upper surface of the mold frame and an edge portion of an upper surface of the prism plate such that the light-shielding adhesive tape adhesively bonds and fixes the prism plate and the mold frame together.

11. A backlight module, comprising: a mold frame, a light guide plate disposed inside the mold frame, a backlight source disposed between the mold frame and the light guide plate, a light-source flexible circuit board disposed on the backlight source and electrically connected to the backlight source, and an optical film assembly disposed on an upper surface of the light guide plate;
the optical film assembly comprising: a diffuser plate and a prism plate disposed on the diffuser plate, the diffuser plate having an end that is adjacent to the backlight source and extends beyond an end of the prism plate that is adjacent to the backlight source;
the light guide plate having an upper surface on which a first double-sized adhesive tape is provided, the first double-sized adhesive tape comprising: a light-source flexible circuit board attaching section located between the light guide plate and the light-source flexible circuit board and a diffuser plate attaching section extending from the light-source flexible circuit board attaching section such that the first double-sized adhesive tape adhesively bonds the light-source flexible circuit board, the light guide plate, and the diffuser plate together;
further comprising: a reflector plate disposed on a lower surface of the mold frame;
wherein a second double-sized adhesive tape is arranged between the lower surface of the mold frame and an upper surface of the reflector plate such that the second double-sized adhesive tape adhesively bonds and fixes the mold frame and the reflector plate together;
a third double-sized adhesive tape being arranged between a lower surface of the light-source flexible circuit board and an upper surface of the mold frame such that the third double-sized adhesive tape adhesively bonds and fixes the light-source flexible circuit board and the mold frame together;
a light-shielding adhesive tape being arranged on an upper surface of the mold frame and an edge portion of an upper surface of the prism plate such that the light-shielding adhesive tape adhesively bonds and fixes the prism plate and the mold frame together.

12. The backlight module as claimed in claim 11, wherein the diffuser plate has an upper surface that is adhesively bonded and fixed to a lower surface of the diffuser plate attaching section of the first double-sized adhesive tape.

13. The backlight module as claimed in claim 11, wherein the diffuser plate has a lower surface that is adhesively bonded and fixed to an upper surface of the diffuser plate attaching section of the first double-sized adhesive tape.
